(19) United States
(12) Patent Application Publication
(10) Pub. No.: US 2017/0369088 A1
(43) Pub. Date: Dec. 28, 2017

(54) HAND TRUCK BRAKE STABILIZER

(71) Applicants: David Dewayne Ingram, Snellville, GA (US); Kendall Delmond Brightharp, Lawrenceville, GA (US); Calvin Germaine Fulwood, Duluth, GA (US)

(72) Inventors: David Dewayne Ingram, Snellville, GA (US); Kendall Delmond Brightharp, Lawrenceville, GA (US); Calvin Germaine Fulwood, Duluth, GA (US)

(21) Appl. No.: 15/636,634

(22) Filed: Jun. 28, 2017

Related U.S. Application Data
(60) Provisional application No. 62/355,785, filed on Jun. 28, 2016.

(51) Int. Cl. B62B 5/04; B60T 7/04; B60T 1/14

(52) U.S. Cl. CPC B62B 5/0433; B62B 5/049; B60T 1/14; B60T 7/045; B62B 5/0461

(57) ABSTRACT

Implementations of hand truck stabilizer are provided. Implementations of a hand truck brake stabilizer according to present disclosure may be mounted to a hand truck to provide a braking function that may help eliminate unintentional movement of the hand truck.

### CROSS REFERENCE TO RELATED APPLICATION

This application claims the benefit of U.S. Patent Application Ser. No. 62/355,785, which was filed on Jun. 28, 2016, and is incorporated herein by reference in its entirety.

### TECHNICAL FIELD

This disclosure relates to implementations of a hand truck brake stabilizer.

### BACKGROUND

Existing hand trucks do not include a mechanism to prevent the hand trucks from rolling.

### BRIEF DESCRIPTION OF THE DRAWINGS

FIG. 1 is a side elevation of a multi-positionable hand truck in a vertical position having a brake stabilizer according to an implementation of the present disclosure thereon.

FIG. 2A is a side elevation of the hand truck of FIG. 1 in a horizontal position.

FIG. 2B is a side elevation similar to FIG. 2A with the brake stabilizer deployed.

FIG. 3 is an enlarged end elevation taken along lines 3A-3A in FIG. 2A;

FIG. 4 is an enlarged end elevation taken along lines 3B-3B in FIG. 2B;

FIG. 5 is a bird's eye exploded isometric view of a brake stabilizer according to an implementation of the present disclosure.

FIG. 6 is a bird's eye exploded isometric view showing the opposite side of a portion of the brake stabilizer shown in FIG. 5.

FIG. 7A is a lateral cross-section showing a foot pedal of a brake stabilizer in a first position according to an implementation of the present disclosure.

FIG. 7B is a lateral cross-section showing a foot pedal of a brake stabilizer in a second position according to an implementation of the present disclosure.

### DETAILED DESCRIPTION

Implementations of a hand truck brake stabilizer are provided. In some implementations, a hand truck stabilizer comprises a main stationary body having a hollow guide. In some implementations, the main stationary body further comprises a front panel, a back panel, one or more top blocks, and one or more corresponding bottom blocks. In some implementations, each of the top blocks and bottom blocks is configured to rest on a top and bottom portion, respectively, of a beam of the hand truck and configured to attach to the front panel and back panel of the main stationary body.

In some implementations, the stabilizer further comprises a foot pedal having a foot pedal bar attached to the foot pedal. In some implementations, the foot pedal bar is configured to move along the hollow guide of the main stationary body. In some implementations, the main stationary body and the foot pedal bar are attached to each other using a compression spring. In some implementations, a proximal end of the compression spring is attached to the main stationary body at a rod extending across the opening of the hollow guide and a distal end of the compression spring is attached to the foot pedal bar at a rod extending across the foot pedal bar. In some implementations, the foot pedal bar comprises a ledge wherein the hollow guide is configured to rest on the ledge in a first position.

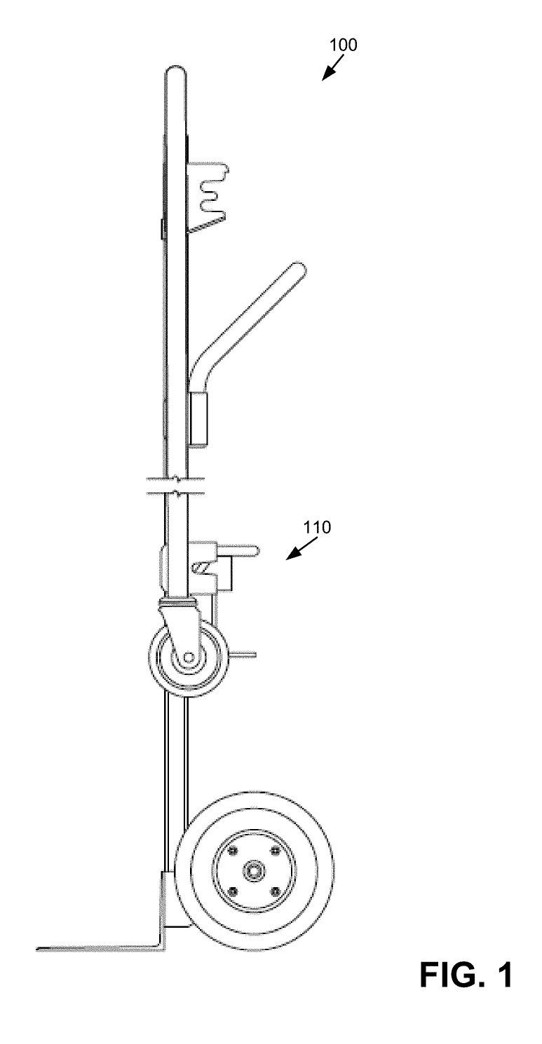

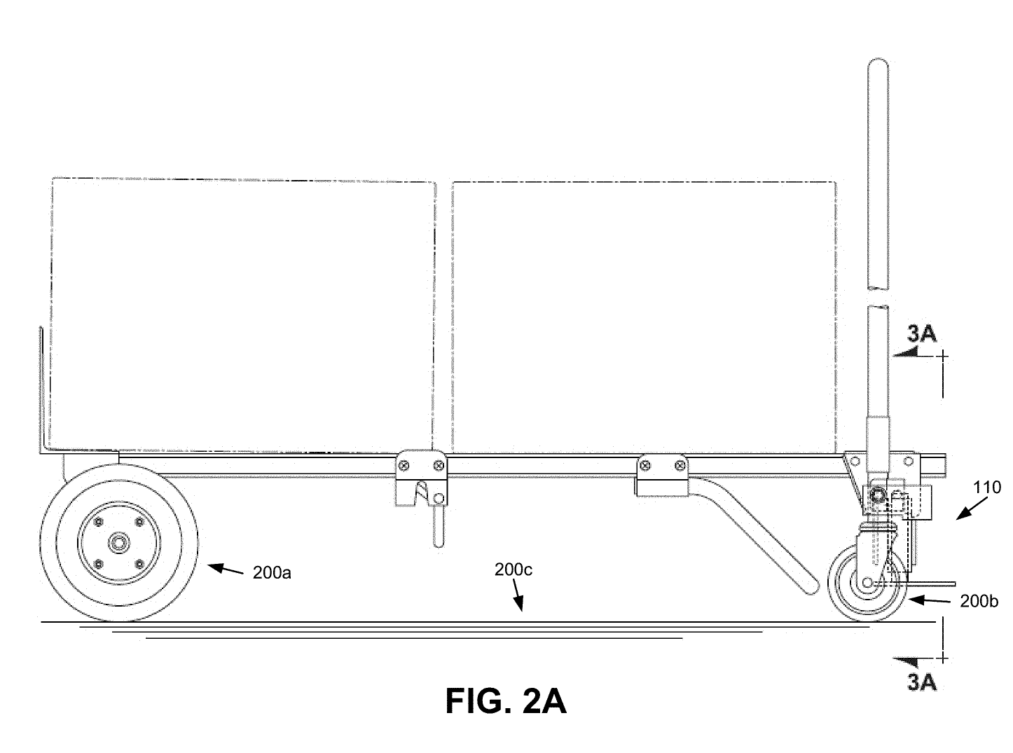

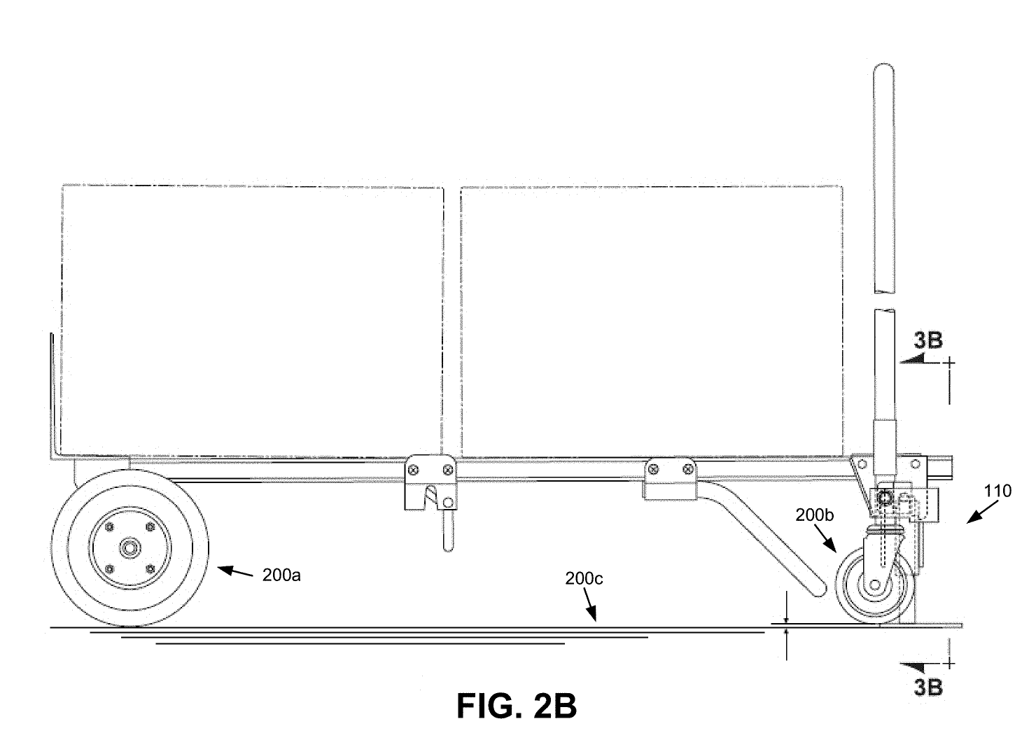

FIGS. 1, 2A and 2B illustrates an example hand truck 100 having a brake stabilizer 110 according to an implementation of the present disclosure. In some implementations, the brake stabilizer 110 may be attached to an existing or further developed hand truck. In some implementations, the hand truck may be a folding or dual purpose hand truck that can be positioned in an horizontal or vertical position for carrying loads. In some implementations, the hand truck 100 may have front wheels 200a and back wheels 200b. As shown in FIGS. 2A and 2B, the brake stabilizer 100 may be used to lift the back heels 200b off a surface 200c to prevent the hand truck 100 from moving. Accordingly, a hand truck brake stabilizer 110 according to present disclosure may be mounted to a hand truck to provide a braking function that may help eliminate unintentional movement of the hand truck.

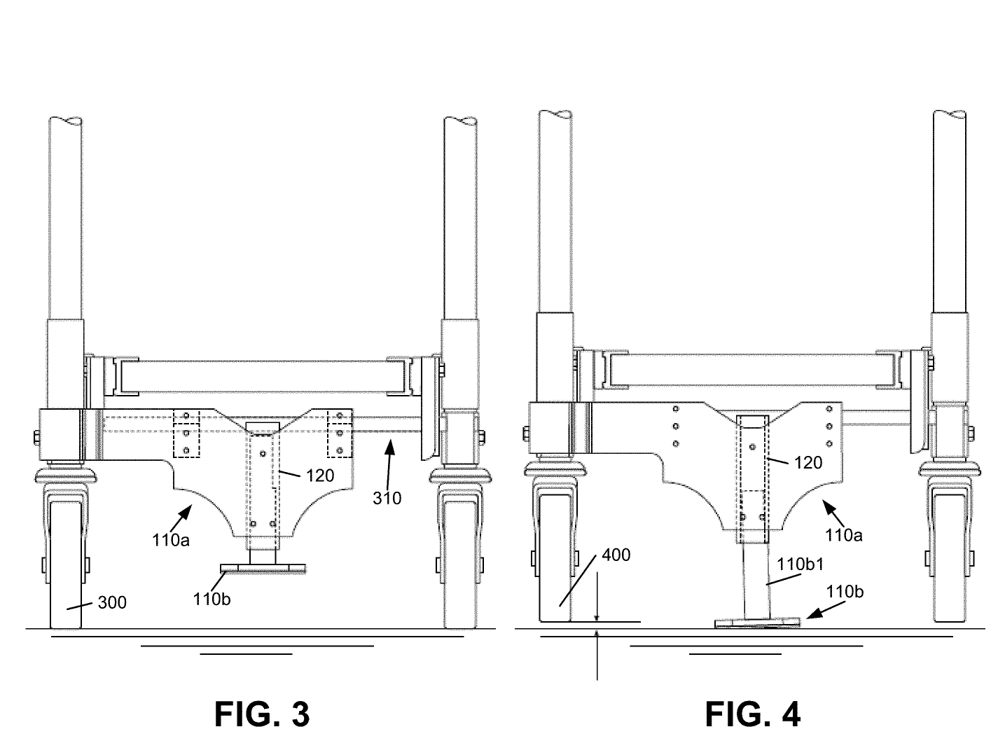

As shown for example in FIGS. 3 and 4, in some implementations, the hand truck brake stabilizer 110 comprises a main stationary body 110a and a foot pedal 110b having a foot pedal bar 110b1 attached thereto that moves inside and outside the main stationary body 110a along a hollow guide 120 to engage and disengage the braking functionality of the hand truck brake stabilizer 110.

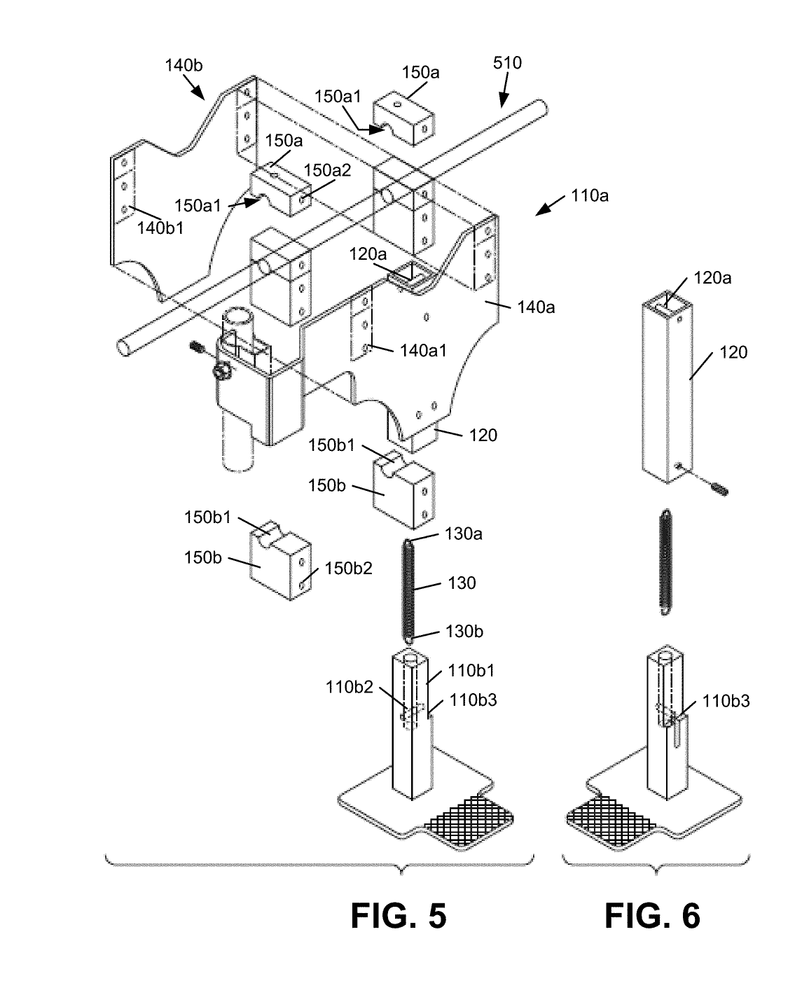

As shown in FIG. 5, in some implementations, the main stationary body 110a comprises a front panel 140a, a back panel 140b, one or more top blocks 150a, and one or more corresponding bottom blocks 150b, and a guide 120.

In some implementations, a rod or beam (e.g., 310, 510) of the hand truck is positioned between the front panel 150a and back panel 140b. As shown in FIGS. 3 and 4, in some implementations, the rod 310, 510 is a rod near the back wheel 300, 400 that extends from one side of the hand truck to the other side of the hand truck. In some implementations, the main stationary body 110a may be attached to the hand truck by positioning one or more top blocks 150a on top of the rod and one or more corresponding bottom block 150b on the bottom of the rod so as to encompass the rod and then attaching the top block(s) 150a and bottom block(s) 150b to the front panel 140a and back panel 140b. In some implementations, the top blocks 150a and bottom block 150b comprise cutouts 150a1, 150b1, respectively, so that the block fit around the rod.

In some implementations, the blocks 150a, 150b may be attached to the front panel 140a and back panel 140b using screws or bolts and nuts and opening 150a2, 150b2 in the blocks and openings 140a1, 140b1 in the front panel 140a and back panel 140b, respectively. In some implementations, the blocks 150a, 150b may be attached to the front panel 140a and back panel 140b using any suitable attachment hardware.

As shown in FIG. 5, in some implementation, the guide 120 may be attached to the front panel 140a. In some implementations, the guide 120 may be attached to the front panel 140a using screws or bolts and nuts. In some implementations, the guide 120 may be attached to the front panel 140a using any suitable attachment hardware.

As shown in FIG. 5, in some implementations, the main stationary body 110a and the foot pedal bar 110b1 are attached to each other via a compression spring 130. In some implementations, the proximal end 130a of the compression spring is attached to the main stationary body and the distal end 130b of the compression spring is attached to the foot pedal bar 110b1.

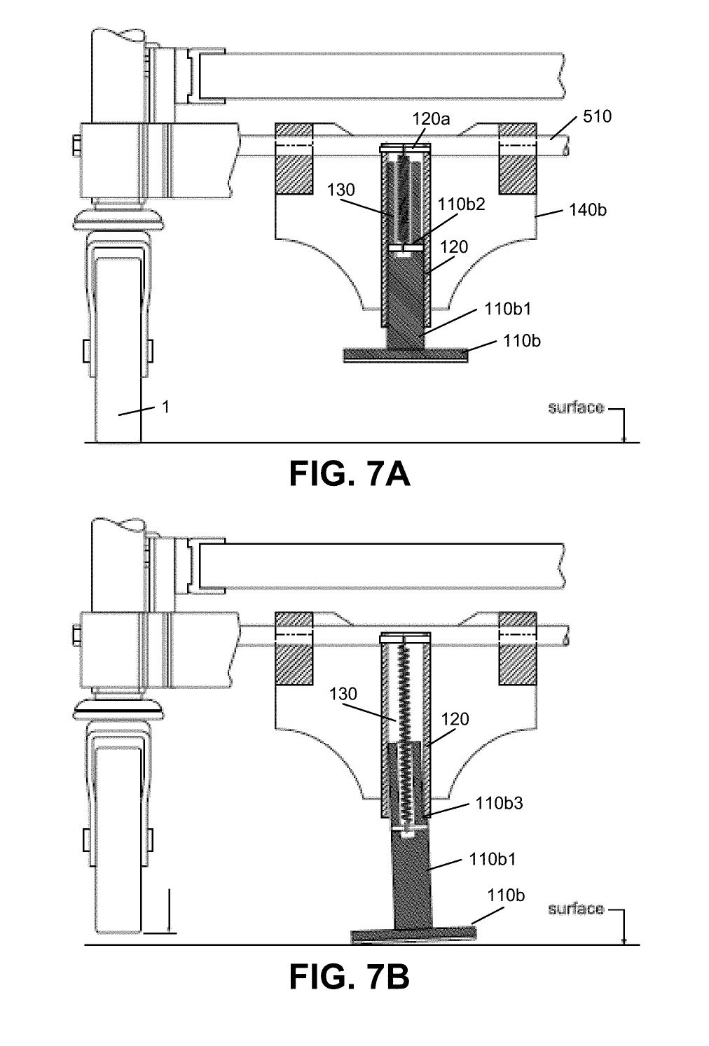

In some implementations, the proximal end 130a of the compression spring 130 is attached to the main stationary body at a rod 120a extending across the opening of the hollow guide 120 at the proximal end of the hollow guide (see FIG. 7A). In some implementations, the distal end 130b of the compression spring 130 is attached to the foot pedal bar 110b1 at a rod 110b2 extending across the foot pedal bar 110b1 (see FIG. 7A).

As shown in FIGS. 4 and 7B, when the brake stabilizer 110 is engaged (i.e., when the foot pedal 110b makes contact with a surface (e.g., ground/floor) (collectively, referred to as “ground”)), the wheels on the end of the hand truck in which the stabilizer is installed are lifted from the ground. This may help to prevent unintentional movement of the hand truck.

In some implementations, the bottom surface of the foot pedal 110b that makes contact with the ground (thereby creating friction) also may help to prevent unintentional movement of the hand truck. In some implementations, the bottom surface of the foot pedal 110b may comprise rubber to help prevent scratching of a surface.

In some implementations, to convert the hand truck from an upright, vertical position to a horizontal position, a handle is pulled down until the wheels make contact with the ground. To engage the braking functionality of the stabilizer 110, a user may place his/her foot on the foot pedal 110b and lift up on the hand truck (thereby causing the foot pedal bar 110b to move outwardly from the main stationary body 110a (see, e.g., FIGS. 7A and 7B)) until the stabilizer locks into place (as discussed below).

In some implementation, the foot pedal bar 110b1 may comprise a ledge 110b3 (see FIGS. 5 and 6) on which the main stationary body (more specifically the guide 120) may rest (see FIG. 7B) thereby locking the stabilizer 110 in place. In some implementations, push down on the foot pedal while the hand truck is in the upright position to engage the braking functionality; thereafter, the handle may be pulled to place the hand truck in a horizontal position.

To disengage the braking functionality, a user may place his/her foot on the foot pedal 110b and lift up on the hand truck until the stabilizer unlocks (e.g., by clearing the ledge 110b3). In some implementations, when the stabilizer is unlocked, the compression spring will cause the foot pedal bar to automatically retract inside the main stationary body 110a (e.g., as shown in FIG. 7A).

Reference throughout this specification to “an embodiment” or “implementation” or words of similar import means that a particular described feature, structure, or characteristic is included in at least one embodiment of the present invention. Thus, the phrase “in an embodiment” or a phrase of similar import in various places throughout this specification does not necessarily refer to the same embodiment.

Many modifications and other embodiments of the disclosure set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A hand truck stabilizer comprising:
a main stationary body having a hollow guide wherein the main stationary body further comprises a front panel, a back panel, one or more top blocks, and one or more corresponding bottom blocks wherein each of the top blocks and bottom blocks is configured to rest on a top and bottom portion, respectively, of a beam of the hand truck; and configured to attach to the front panel and back panel of the main stationary body; and
a foot pedal having a foot pedal bar attached to the foot pedal wherein the foot pedal bar is configured to move along the hollow guide of the main stationary body,
wherein the main stationary body and the foot pedal bar are attached to each other via a compression spring,
wherein a proximal end of the compression spring is attached to the main stationary body at a rod extending across the opening of the hollow guide at the proximal end of the hollow guide and a distal end of the compression spring is attached to the foot pedal bar at a rod extending across the foot pedal bar, and
wherein the foot pedal bar comprises a ledge wherein the hollow guide is configured to rest on the ledge in a first position.
